(19) United States
(12) Patent Application Publication
(10) Pub. No.: US 2013/0063784 A1
(43) Pub. Date: Mar. 14, 2013

(54) PRINTING SYSTEM WITH IN-LINE FINISHING

(71) Applicants: Shamai Opfer, Mazkeret Batya (IL); Elad Baram, Dorot (IL); Jody Terrill, Boise, ID (US); Yossi Adam, Rehovot (IL); Eli Bitan, Netanya (IL); Tamir Hativa, Tel Aviv (IL); Shmulik Tischler, Ness Zionna (IL); Noga Tal, Rehovot (IL)

(72) Inventors: Shamai Opfer, Mazkeret Batya (IL); Elad Baram, Dorot (IL); Jody Terrill, Boise, ID (US); Yossi Adam, Rehovot (IL); Eli Bitan, Netanya (IL); Tamir Hativa, Tel Aviv (IL); Shmulik Tischler, Ness Zionna (IL); Noga Tal, Rehovot (IL)

(73) Assignee: HEWLETT-PACKARD DEVELOPMENT COMPANY, L.P., Houston, TX (US)

(21) Appl. No.: 13/698,559

(22) PCT Filed: May 17, 2010
(86) PCT No.: PCT/US2010/035102

§ 371 Date: Nov. 16, 2012

(51) Int. Cl. G06K 15/02

(52) U.S. Cl. 358/1.15

(57) ABSTRACT

A printing system includes a printing station; a finishing line controller for controlling operation of one or more finishing devices arrangeable in-line with the printing station and a first communication link between the printing station and the controller for communicating job commands from the printing station to the finishing line controller to be translated into finishing action commands by the finishing line controller and communicated to said one or more finishing devices.

### RELATED APPLICATIONS

The present application claims the priority under 35 U.S.C. 119(a)-(d) or (f) and under C.F.R. 1.55(a) of previous International Patent Application No. PCT/US2010/035102, filed May 17, 2010, entitled “Printing System with In-Line Finishing,” which is incorporated herein by reference in its entirety.

### FIELD OF THE INVENTION

The present invention relates to printing. More specifically the present invention relates to a printing system with in-line finishing.

### BACKGROUND

In digital printing a substantial value lies in efficient short run print production. Automation of the entire print production process is imperative as post press processing seem to be a major bottleneck in digital print production. Traditional post press processing carry very heavy costs of labor, which might make print jobs unprofitable, and also increase the chances for errors in the process.

Customers expect printer vendors to provide automated finishing lines, either as a near-line set-up or as an in-line set-up. High volume application focused customers expect in-line finishing as a key building block of a fully automated production process.

Integrating automated finishing devices requires complex interaction with the press, the Digital Front End (DFE) and upstream workflow system.

Looking at the printing industry trends, one can see that more and more applications require mixed digital solutions, together with increased automation, and cost savings.

### SUMMARY

According to embodiments of the present invention there is provided a printing system. The system includes a printing station, and a finishing line including one or more finishing devices arranged to be placed in-line with the printing station. A finishing line controller is provided for controlling operation of said one or more in-line finishing devices; and a first communication link between the printing station and the controller for communicating job commands from the printing station to the finishing line controller to be translated into finishing action commands by the finishing line controller and communicated to said one or more finishing devices.

Furthermore, according to embodiments of the present invention, there is provided a finishing line system for incorporation in a printing system that includes a printing station. The finishing line system includes a finishing line with one or more finishing devices arranged to be placed in-line with the printing station. A finishing line controller is provided for controlling operation of the in-line finishing devices. A first communication link is provided between the printing station and the controller for communicating job commands from the printing station to the finishing line controller to be translated into finishing action commands by the finishing line controller and communicated to said one or more finishing devices.

Furthermore, according to embodiments of the present invention, there is provided a method for printing with in-line finishing, using a printing system which includes one or more finishing devices in line with a printing station, a finishing line controller for controlling operation of the finishing devices and a first communication link between the printing station and the controller. The method includes communicating job commands from the printing station to the finishing line controller; translating the job command into finishing action commands by the finishing line controller; and communicating the finishing action commands from the finishing line controller to said one or more finishing devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a printing system with an in-line finishing line, according to embodiments of the present invention.

FIG. 2 illustrates a method for printing with in-line finishing, according to embodiments of the present invention.

FIG. 3 illustrates an algorithm for operating a finishing line controller of a printing system with an in-line finishing line, according to embodiments of the present invention.

### DETAILED DESCRIPTION

According to embodiments of the present invention, a printing system with an in-line finishing line is herein disclosed that includes a finishing line controller for interfacing the finishing line devices with a printing station and for controlling one or more finishing devices of the finishing line.

Such system may include, for example, a printing assembly, such as, for example, a sheet or web fed press, for example a digital press, for example an LEP (liquid electrophotographic) printer, which outputs printed sheets or web, with a stacker (in the case of sheets being the printed material) that stacks sheets of a single print job (or of multiple print jobs), and one or more finishing in-line devices, each device designed to carry out one or more finishing actions, such as, for example, scoring, cutting, slitting, trimming, folding and binding.

A FLC (finishing line controller) is designed to interface with digital presses using a near real-time interface to facilitate dynamic operation of the finishing line devices during the execution of a print job. A “print job” or “job” in the context of the present invention relates to a complete print task that includes the actual printing (which is carried out by the press (also referred to as the “printing station”) and subsequent finishing (which is carried out by the finishing line devices).

Print job instructions may be provided in JDF (Job Definition Format), a standardized format commonly used in the printing industry. A DFE associated with a press receives the job specification in a JDF communication and divides the job specification command in to a series of press specific commands (typically also in JDF format or JMF—Job Messaging format, which is part of the JDF specification and is also typically built in XML).

With a direct communication line between the press and the FLC the operation of the finishing line devices becomes more dynamic, as finishing commands may be sent from the press to the FLC during a print job, rather than sending such commands in advance before the finishing line devices commence their operation on a printed material that was printed by the press, as was previously the case. Such approach facilitates better integration of finishing solutions for printing jobs. The FLC enables simple, modular and automated finishing solutions for an inline finishing system (and also for a near line finishing system).

The FLC may also have a direct communication link to the DFE (or other upstream workflow module), allowing the DFE to directly affect the finishing operations of the in-line finishing line devices.

The communication schemes which are used in these communication links may be standard (e.g. JDF, JMF) or non-standard communication schemes.

The FLC may receive job specifications (sometimes referred to as “tickets”), e.g. in the JDF (Job Definition Format) standard from an upstream workflow module (e.g. DFE) and interfaces with the digital press using a near real-time interface or an approximately real-time interface. The near real-time interface integrates an in line solution of press and finishing job (that includes printing and finishing), and facilitates rapid switching to new jobs, automatically configuring the finishing line to the new job, whenever a current job ends. A printing system with an FLC facilitates better communication between a digital printing press and its associated in-line finishing line devices. According to embodiments of the present invention this approach may include the following principles with respect to press-FLC communications:

1. There may be near real-time communication between the Press and the FLC.

2. The communication protocol between the press and the FLC may be executed over standard Ethernet connection, and defined as a scheme, for example a proprietary scheme, using standard XML

3. The communication protocol between the press and the FLC may deal with generic synchronization and status messages exchange and it may not contain concrete finishing parameters. These concrete finishing parameters may be handled only in the upper level, e.g. using JDF/JMF communication protocol).

4. Synchronization between the finishing line device and the press may be based on sending forecast of jobs and sheets from the press to the FLC. Before a job starts printing, the press may alert the FLC of a pending print job about to start and waits for an acknowledgement before printing commences. In addition, the FLC may hold printing of a job before printing starts and to resume printing when the FLC is ready. Before printing each sheet, the press may inform the FLC about it in advance, e.g. with extendible metadata, with future usage of entering null cycles for planning delay needed for finishing operations.

5. The communication protocol between the press and the FLC may support jobs manipulations during printing, using minimal and generic synchronization commands.

6. To facilitate error recovery, when a print session ends (either planned or due to an error in either side), the press and the FLC exchange information so as to enable resuming of printing, following the last successful finished sheet, in an automated and synchronized way. The protocol allows for the FLC to apply its finishing-related logic for error recovery.

7. The protocol may support various types of stop print requests from FLC to the press, both urgent and controlled. For example, in the case when consumables are about to run out, or when there is a need to end printing on the next complete copy.

8. The protocol may include generic status messages, supporting multi-language platforms (localized). The press system with the FLC may also use standard JDF/JMF communications protocol between the FLC and upstream workflow module, such as DFE (Digital Front End). This may apply both for in-line and near-line finishing lines. The DFE may be connected both to the press and to the FLC. The interface to between the DFE and the press may be based on existing press API (application programming interface). The interface between the DFE and the finishing device may be based on JDF protocol.

The DFE may issue job intent and job layout, e.g. in JDF, to the FLC which will translate this command into actual finishing action commands and communicate the actual action commands to the finishing line devices.

The DFE may manage jobs carried out by the finishing line devices via the FLC. The DFE may submit finishing job commands to the finishing line devices (via the FLC) when the corresponding printing jobs are submitted to the press. The DFE may remove jobs when these jobs are deleted from the press or from the DFE. The DFE may update the finishing job command at the FLC when the job properties are changed. Optionally, the communication link between the FLC and the press, and the communication line between the DFE and the FLC may be used to exchange current job status information. Such status may be displayed on a display screen.

The FLC may monitor finishing devices configuration and status. Whenever a finishing device status is changed—the FLC may reflect it on the DFE. Whenever a finishing device configuration is changed—the FLC may reflect it on the DFE.

The DFE may enable selecting a list of devices to process the job, and for each device setting its properties.

During print, the FLC dynamically sends actual finishing action commands to the appropriate finishing device, coordinated with the press via the communication link between the press and the FLC.

When an error occurs, the FLC may send a reprint request to the DFE for automatic error recovery, e.g. using JMF messages.

The FLC may be assigned to gather device information from the finishing line devices during startup.

The FLC may be used to issue calibration commands to the finishing line devices.

A printing system according to embodiments of the present invention is capable of connecting to a wide variety of finishing devices with diverse functionalities. A printing system according to embodiments of the present invention is capable of performing automatic set-up of the finishing devices. It may control and work with concatenated finishing devices, both in line and near line. Advanced error handling and recovery may also be achieved. A printing system according to embodiments of the present invention facilitates connectivity with upstream workflow systems. It may report device and job statuses to upstream devices (of the whole concatenated line), support last minute changes in the printed jobs, and allow an operator to perform manual printing interventions.

A printing system according to embodiments of the present invention is capable of providing finishing integrity verification and supporting finished document integrity.

The FLC may serve as a universal high-level in-line finishing interface, allowing connecting in-line finishing device with a printing station via the FLC using standard protocols, such as, for example ICD (interface control document), thus facilitating integrated print job solutions.

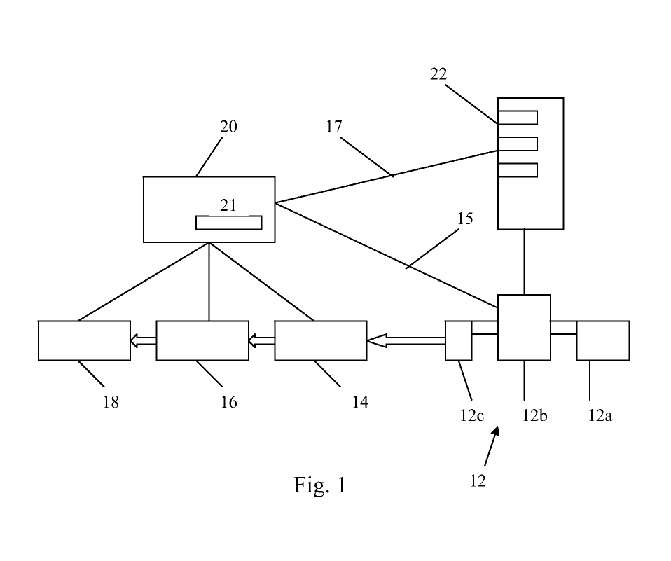

Reference is made to FIG. 1 illustrating a printing system with an in-line finishing line, according to embodiments of the present invention.

The printing system illustrated in FIG. 1 includes a printing station 12, which may include, for example, sheet feeder 12a, press 12b and stacker 12c. Printing station communicates with DFE 22, which is capable of loading files from various sources (such as network—e.g. Internet or intranet—sources) and process the files to be output by the printing system.

In-line with the printing station is a finishing line with several finishing devices 14, 16 and 18, which are designed to perform one or more finishing actions on the printed sheets that emerge from the printing station. The finishing devices are designed to carry out one or more finishing actions, such as, for example, scoring, cutting, slitting, trimming, folding and binding.

According to embodiments of the present invention a Finishing Line Controller (FLC) 20 is provided that automatically manages the operation of the finishing devices, and communicates with the printing station via communication link 15 or with DFE 22 via communication link 17. FLC 20 controls and coordinates the finishing actions which are to be carried out by the finishing line devices. FLC 20 may generate status reports relating to the finishing line, set up the finishing line devices, Manages the finishing job as it advances along the finishing line. FLC 20 may also generate reports on failed sheets, copies or records, and may also generate reprint requests.

Communication link 15 is provided between FLC 20 and printing station 12, and communication link 17 is provided between FLC 20 and DFE 22. the communication links may use, for example, Ethernet wireless, internet or other suitable communication protocols The communication protocol may also be defined as a proprietary scheme, e.g. using standard XML.

FLC 20 may receive, for example, Job Messaging Format communication (e.g. job tickets in JDF—Job Definition Format standard) from DFE 22.

According to embodiments of the present invention Bindery Agent (BA) 21 may be hosted within FLC 20. BA 21 may comprise hardware, software and/or firmware to translate a job command (e.g. in JDF) to the actual finishing actions JDF (e.g. according to industry standard Interoperability Conformance Specification—ICS—standard). Finishing actions may include, for example, scoring, cutting, slitting, trimming, folding, binding and other finishing actions.

BA 21 may also, for example, fill in missing information in JDF layout supplied to FLC 20, and check job constraints.

BA 21 may be provided as a module in the FLC. Alternatively, the BA functions may be fully integrated in the FLC itself.

FLC 20 may be designed to gather, at system start-up, information from the devices it communicates with. FLC 20 may be designed to apply correct setup to the finishing devices before performing the printing job. In a production run FLC 20 may set-up or change automation parameters for the job, issue warnings, such as the need for consumable replenish (e.g. staples), perform error handling (e.g. jam at the printing station or at any other place along the finishing line) and error recovery (e.g. resume printing, issue reprint requests).

According to embodiments of the present invention, the communication links may include real time or near real-time interfaces. According to embodiments of the present invention near real-time interface enables the printing system, in its in-line configuration of press and finishing devices, to print and finish jobs, and to switch to new jobs, automatically configuring the finishing line to the new job, whenever the current job ends.

A printing system according to embodiments of the present invention may include the following features: Near real-time communication between the press (printing station) and the FLC. Communication protocol between the press and FLC may be executed over standard Ethernet connection or other communication protocol. The communication protocol may address generic synchronization and status messages exchange. Finishing parameters may be handled through JDF/JMF communication interface between FLC and DFE. Synchronization may be based on sending forecast of jobs and sheets from the printing station to FLC. Before a printing job starts, the printing station may communicate an advance communication to the FLC and wait for an acknowledgement to start. In addition, there may be a mechanism for FLC to hold a printing job before it starts, and to print and to resume printing when FLC is ready. Before printing each sheet, the printing station may send an advance communication to the FLC, with extendible metadata, including information on future usage of incoming blank sheets so as to facilitate planning delays which may be needed for finishing operations. An advance communication may also include, for example, estimated speed of printing for the sheet, additional information like synchronization boundary for future digital integrity check, and as acknowledgement message back from the FLC to the printing station specific request for this sheet printing like increased time of printing

The FLC allows job manipulations during printing, using generic synchronization commands. To allow error recovery, when a print session ends (either planned or due to an error in either side), the printing station may communicate with the FLC to resume printing following the last successful finished sheet, in an automated and synchronized way. The communication protocol allows the FLC to apply finishing-related logic for error recovery. The communication protocol may support various types of stop print requests from FLC to the printing station, urgent and controlled, for example, in the case when consumables are about to end, or when it is needed to end printing on the next complete copy. Generic status messages may be used in the communication protocol, supporting multi-language platforms (localized).

According to embodiments of the present invention synchronization of the in-line finishing device may be controlled by the FLC. This may be achieved, for example, by providing barcode on the printed sheets or a banner page. A banner page may be printed at the beginning of a new job (or every predetermined number of sheets, records). The FLC is adapted to use the synchronization markings (e.g. detected by one or more optical detectors placed in-line) for proper operation.

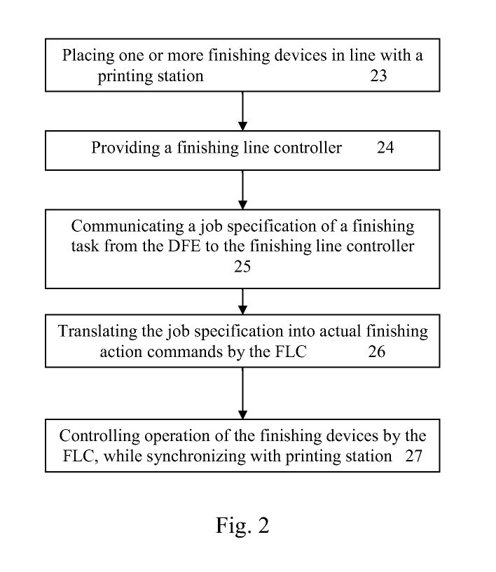

FIG. 2 illustrates a method for printing with in-line finishing, according to embodiments of the present invention. The method includes placing one or more finishing devices in line with a printing station 23, providing a finishing line controller 24 for controlling operation of said one or more finishing devices and a first communication link between the printing station and the controller, communicating a job specification of a finishing task from a DFE to the finishing line controller 25, translating the finishing job specification into actual finishing action commands by the FLC 26, and controlling operation of the finishing devices by the FLC, while synchronizing with printing station 27.

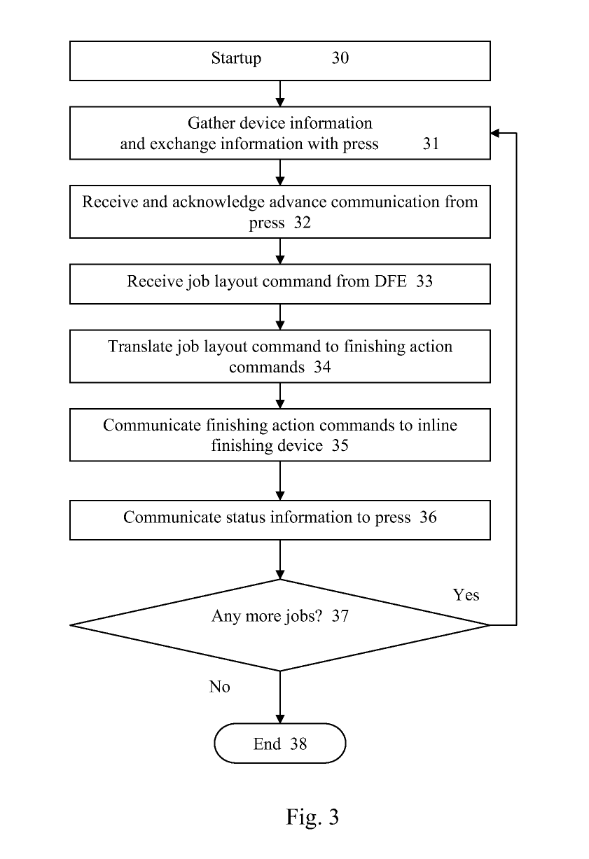

FIG. 3 illustrates an algorithm for operating a finishing line controller of a printing system with an in-line finishing line, according to embodiments of the present invention.

Upon startup 30 the FLC gathers device information from the finishing line devices and exchanges this information with the DFE 31. The DFE may issues an advance command which is received and acknowledged by the FLC 32.

A job layout is issued by the DFE and received by the FLC 33. The FLC translates it into finishing action commands 34, and communicates the finishing action commands to the designated finishing device 35. During operation the FLC may communicate status information to the press 36.

It is then determined whether the print jobs are finished or where there are anymore pending jobs 37. If there exists a new job the above steps are repeated for the next job, else the algorithm terminates 38.

Aspects of the present invention, as may be appreciated by a person skilled in the art, may be embodied in the form of a system, a method or a computer program product. Similarly, aspects of the present invention may be embodied as hardware, software or a combination of both. Aspects of the present invention may be embodied as a computer program product saved on one or more computer readable medium (or mediums) in the form of computer readable program code embodied thereon.

For example, the computer readable medium may be a computer readable signal medium or a computer readable storage medium. A computer readable storage medium may be, for example, an electronic, optical, magnetic, electromagnetic, infrared, or semiconductor system, apparatus, or device, or any combination thereof.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code in embodiments of the present invention may be written in any suitable programming language. The program code may execute on a single computer, or one a plurality of computers.

Aspects of the present invention are described hereinabove with reference to flowcharts and/or block diagrams depicting methods, systems and computer program products according to embodiments of the invention.

1-18. (canceled)

19. A printing system comprising:
a printing station;
a finishing line controller for controlling operation of one or more finishing devices arrangeable in-line with the printing station; and
a first communication link between the printing station and the controller for communicating job commands from the printing station to the finishing line controller to be translated into finishing action commands by the finishing line controller and communicated to said one or more finishing devices.

20. A printing system as claimed in claim 1, comprising:
a digital front end controller with a communication link to the printing station; and
a second communication link between the digital front end controller and the finishing line controller.

21. A printing system as claimed in claim 1, wherein said finishing line controller is designed to execute an algorithm which includes one or more instructions selected from the group of instructions consisting of:
gathering device information from said one or more finishing devices;
receiving and acknowledging an advance communication from the printing station;
communicating status information to the printing station; and
generating an error recovery request.

22. A printing system as claimed in claim 1, comprising a bindery agent hosted in the finishing line controller.

23. A printing system as claimed in claim 1, wherein the first communication link comprises a near real time interface.

24. A printing system as claimed in claim 1, further comprising, a finishing line comprising one or more finishing devices arranged to be placed in-line with the printing station and controlled by said finishing line controller.

25. A printing system as claimed in claim 6, wherein said finishing devices each perform one or more finishing actions, wherein said one or more finishing actions are selected from the group of finishing actions that consists of: scoring, cutting, slitting, trimming, folding and binding.

26. A finishing line system for incorporation in a printing system that includes a printing station, the finishing line system comprising:
a finishing line comprising one or more finishing devices arranged to be placed in-line with the printing station;
a finishing line controller for controlling operation of said one or more in-line finishing devices; and
a first communication link between the printing station and the controller for communicating job commands from the printing station to the finishing line controller to be translated into finishing action commands by the finishing line controller and communicated to said one or more finishing devices.

27. A finishing line system as claimed in claim 8, wherein the printing system comprising includes a digital front end controller with a communication link to the printing station, the finishing line system comprising a second communication link between the digital front end controller and the finishing line controller.

28. A finishing line system as claimed in claim 8, wherein said finishing line controller is designed to execute an algorithm which includes one or more instructions selected from the group of instructions consisting of:
gathering device information from said one or more finishing devices;
receiving and acknowledging an advance communication from the printing station;
communicating status information to the printing station; and
generating an error recovery request.

29. A finishing line system as claimed in claim 8, comprising a bindery agent hosted in the finishing line controller.

30. A finishing line system as claimed in claim 8, wherein the first communication link comprises a near real time interface.

31. A finishing line system as claimed in claim 8, wherein said one or more finishing actions are selected from the group of finishing actions that consists of:
scoring, cutting, slitting, trimming, folding and binding.

32. A method for printing with in-line finishing, using a printing system, the printing system comprising:
one or more finishing devices in line with a printing station;
a finishing line controller for controlling operation of said one or more finishing devices; and
a first communication link between the printing station and the controller;
the method comprising:
communicating job commands from the printing station to the finishing line controller;
translating the job command into finishing action commands by the finishing line controller; and
communicating the finishing action commands from the finishing line controller to said one or more finishing devices.

33. A method as claimed in claim 14, comprising:
providing a digital front end controller with a communication link to the printing station and a second communication link between the digital front end controller and the finishing line controller;
communicating job messages from the digital front end controller to the finishing line controller.

34. A method as claimed in claim 14, comprising one or more method steps selected from the group of method steps consisting of:
gathering device information from said one or more finishing devices;
receiving and acknowledging an advance communication from the printing station;
communicating status information to the printing station; and
generating an error recovery request.

35. A method as claimed in claim 14, comprising providing a bindery agent hosted in the finishing line controller.

36. A method as claimed in claim 14, comprisng operating the first communication link as a near real time interface.

37. A method as claimed in claim 14, comprising using the finishing devices for performing one or more finishing actions selected from the group of finishing actions that consists of: scoring, cutting, slitting, trimming, folding and binding.
